(19) United States
(12) Patent Application Publication
(10) Pub. No.: US 2026/0056735 A1
(43) Pub. Date: Feb. 26, 2026

(54) SYSTEMS AND METHODS FOR AUTOMATIC CODE ANALYSIS AND DOCUMENT GENERATION

(71) Applicant: INTUIT INC., Mountain View, CA (US)

(72) Inventors: Daniel GOUIN, Mountain View, CA (US); Vijay Kumar HIREMATH, Bangalore (IN); Chirag DAVE, Mountain View, CA (US); Kalapriya KANNAN, Bangalore (IN)

(73) Assignee: INTUIT INC., Mountain View, CA (US)

(21) Appl. No.: 18/813,087

(22) Filed: Aug. 23, 2024

(51) Int. Cl. G06F 8/73; G06F 40/30

(52) U.S. Cl. CPC G06F 8/73; G06F 40/30

(57) ABSTRACT

The invention relates generally to systems and methods for generating a document by collecting code and contextual information. Utilizing a generative artificial intelligence (AI) model, the system generates prompts based on the collected data and embeds these prompts into the code. The system then generates a document that formats the information associated with the code and the embedded prompts, providing a comprehensive view of the code's functionality, usage, performance metrics, and business logic.

### BACKGROUND

In the realm of software, the ability to effectively reuse code assets is important. Analysts and developers often spend considerable time creating, refining, and deploying code that performs a variety of functions, from data extraction to complex transformations. However, despite the potential for these code assets to be reused, the code assets are often not reused due to the lack of comprehensive and accessible documentation that provides a clear understanding of the code's purpose, context, and usage.

Currently, it is estimated that less than 1% of analyst code assets are reused. The existing documentation, where it exists, tends to offer limited insights, focusing on syntactical explanations or basic query functions without delving into the broader context or operational details of the code. Such superficial documentation fails to convey the full spectrum of information needed to determine the suitability of code assets for specific use cases.

The challenge is further compounded by the fact that much of the knowledge about a code asset's utility resides as institutional knowledge with the code's authors or long-term users. This knowledge is rarely codified in a manner that is easily transferable or searchable, making the process of understanding and leveraging existing code assets time-consuming and difficult. Addressing this gap in knowledge transfer and documentation would greatly enhance the efficiency and effectiveness of software development.

### BRIEF DESCRIPTION OF THE DRAWINGS

To facilitate a fuller understanding of the present invention, reference is now made to the attached drawings. The drawings should not be construed as limiting the present invention but are intended only to illustrate different aspects and embodiments of the invention.

FIG. 1 is a block diagram illustrating a system according to example embodiments.

FIG. 2 is a flow diagram illustrating a method according to example embodiments.

FIG. 3A is a diagram illustrating an analyst card according to example embodiments.

FIG. 3B is a diagram illustrating an analyst card according to example embodiments.

FIG. 4 is a block diagram illustrating a system according to example embodiments.

FIG. 5 is a flow diagram illustrating a method according to example embodiments.

FIG. 6 is a flow diagram illustrating a method according to example embodiments.

### DETAILED DESCRIPTION

Example embodiments of the invention will now be described to illustrate various features of the invention. The embodiments described herein are not intended to be limiting as to the scope of the invention, but rather are intended to provide examples of the components, use, and operation of the invention.

The present disclosure generally relates to systems and methods that address the technological problem of inefficient code documentation and reuse in software development environments. The system comprises interconnected modules—data collection, prompt generation, prompt embedding, and description generation modules—that automate and enhance the process of creating comprehensive code documentation.

In example embodiments, the system collects code and several other categories of contextual information related to the code. The system may preprocess or clean the code and contextual information to prepare the information for analysis, including deduplication, corruption detection, and format standardization.

The system may analyze the code and contextual information with natural language processing (NLP) and machine learning (ML) techniques, including tokenization, part-of-speech tagging, entity recognition, and semantic analysis to parse code structures from the code and associated information. From this analysis, the system generates prompts that describe and contextualize the code, then embeds these prompts within the code. The system may then generate documentation, herein referred to as analyst cards, through large language models (LLMs) from the embedded prompts and associated code sections.

This system provides a technological solution to the problem of inefficient and inconsistent code documentation by automating the entire code documentation process from data collection to documentation generation. From a technical perspective, the automation process requires several data processing steps and techniques that have no equivalent in the realm of manual code documentation. These are described in detail below. Furthermore, by leveraging machine learning algorithms and natural language processing techniques, the system can identify patterns, relationships, and dependencies within code structures that may not be immediately apparent to human developers. In addition, the system significantly reduces the manual effort required in creating comprehensive code documentation, improves the quality and consistency of documentation across different code assets, and enhances code reusability. The system's ability to understand complex code structures, extract relevant contextual information, and generate human-readable documentation represents an advancement in software development tools and practices. Moreover, the system's automated approach to code analysis and documentation generation allows for real-time updates and version control, ensuring that the documentation remains synchronized with the evolving codebase. This dynamic nature of the system represents a significant improvement over traditional static documentation methods, enhancing the overall efficiency and accuracy of software development processes.

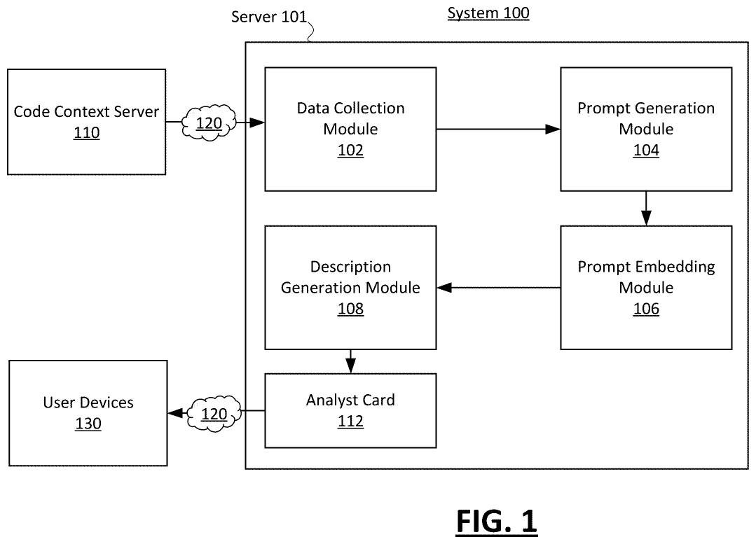

FIG. 1 illustrates a system 100 for generating contextual documentation of code. The system 100 may include a server 101, a code context server 110, one or more user devices 130, and a network 120. The server 101 may include a data collection module 102, a prompt generation module 104, a prompt embedding module 106, and a description generation module 108. These modules may be collections of code or instructions stored on a media representing a series of machine instructions that implement one or more actions explained below. Each module can be stored within a memory or data storage unit associated with the server 101.

The network 120 may be one or more of a wireless network, a wired network, or any combination of wireless network and wired network. For example, the network 120 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like. The network 120 may translate to or from other protocols to one or more protocols of network devices. Although the network 120 is depicted as a single network, it should be appreciated that according to one or more examples, the network 120 may include a plurality of interconnected networks, such as, for example, the Internet, a service provider's network, a cable television network, corporate networks, such as credit card association networks, and home networks. The Network 120 may further include or be configured to create one or more front channels, which may be publicly accessible and through which communications may be observable, and one or more secured back channels, which may not be publicly accessible and through which communications may not be observable.

The code context server 110 may collect and store one or more data regarding code and contextual data associated with code. In example embodiments, the data stored in the code context server 110 may include code, SQL identification, query logs, input and output data, query clustering, and other data associated with the code. Other data may include more contextual information, including a data model of the code, a lineage analysis exploring the versions or iterations of the code, explainability integration, a profile of experiments done on the code, including test time, validation, configurations, setup, and run-time instructions for the code; as well as test profiling of the code including performance metrics, execution time, accuracy, and truth metrics, e.g., false positives. Other kinds of contextual information not described herein may be stored.

In example embodiments, the code context server 110 may collect this data by implementing automated data harvesting algorithms that scan and query various databases and repositories where code assets, including contextual information, are stored. The code context server 110 may also interface with development environments and version control systems to extract relevant metadata and change logs. Additionally, the code context server 110 may provide an interface for users to manually input or upload code and associated contextual information, ensuring that even non-standardized or ad-hoc code assets can be documented.

The data collection module 102 may receive, retrieve, and ingest the data from the code context server 110 over the network 120. The data collection module 102 may receive the data continuously, in batches, or in response to a data query from the server 101.

Upon receiving the code and contextual information, the data collection module 102 may preprocess or clean the information by identifying and removing duplicate entries, ensuring that each piece of code and its associated contextual information is represented uniquely within a dataset. The data collection module 102 may also scan for and rectify any corrupted data entries, such as those that are incomplete or improperly formatted, which could hinder the subsequent analysis of the data. In preparing the code and contextual information for ingestion into the prompt generation module 104, the data collection module 102 may standardize the data formats and normalize the values to create a consistent dataset that can be effectively processed by the prompt generation module 104, including converting various data types to a common format, aligning disparate data structures, and resolving inconsistencies in naming conventions and coding styles.

In example embodiments, the data collection module 102 may encounter multiple versions of the same SQL query stored in different repositories. The data collection module 102 may identify these duplicates by comparing the query structures and associated metadata. It may then retain the most recent or most complete version while archiving or removing the outdated entries. This process ensures that each unique code asset is represented only once in the dataset, reducing redundancy and potential confusion in subsequent analysis.

In other example embodiments, the data collection module 102 may process a mix of Python and SQL code assets. The data collection module 102 may standardize these diverse code formats by converting them into a common intermediate representation. As a nonlimiting example, data collection module 102 may extract information such as function names, input parameters, and output structures from both Python functions and SQL queries, storing this information in a unified format. This standardization allows the prompt generation module 104 to process code assets consistently, regardless of their original language.

Additionally, the data collection module 102 may encounter inconsistencies in naming conventions across different code assets. As a nonlimiting example, some assets may use camelCase for variable names, while others use snake_case. The data collection module 102 may apply a set of predefined rules to normalize these naming conventions. The data collection module 102 may also leverage machine learning techniques to identify and group semantically similar variables or functions that have been named differently across various code assets.

The prompt generation module 104 may receive or retrieve the preprocessed code and contextual information from the data collection module 102. The prompt generation module 104 may ingest this information and generate, via a generative AI model, one or more prompts. Generally, these prompts may include distilled or summarized versions of the data received from the data collection module 102. Upon analyzing the inputs, the prompt generation module 104 may perform data extraction from the code and contextual information and then generate prompts based on the extracted information.

The prompt generation module 104 may use a combination of techniques to generate the prompts. In example embodiments, the prompt generation module 104 may analyze the inputs using NLP and machine learning techniques. The prompt generation module 104 may perform tokenization and part-of-speech tagging, both of which may involve breaking down the text associated with the code and contextual information into meaningful units and identifying the grammatical role of each word. Furthermore, the prompt generation module 104 may perform entity recognition and relation extraction, which may involve identifying entities and relationships within the text.

The prompt generation module 104 may analyze the code and extract information from the code, including, without limitation, functions, variables, dependencies, and comments from the code. In example embodiments, the prompt generation module 104 may Abstract Syntax Trees (AST) parsing. Furthermore, the prompt generation module 104 may analyze the data from the inputs including the data schema, data dictionary, and sample data to identify entities, data types, and relationships among the code. Furthermore, the prompt generation module 104 may ingest dashboards to better understand the visual representations of the data and metrics associated with the code. Based on the analysis of these dashboards, the prompt generation module 104 may generate prompts that focus on the specific insights revealed by the dashboards, such as, without limitation, factors contributing to the decline in sales or a forecast of future sales based on trends observed in a dashboard.

Furthermore, the prompt generation module 104 may employ knowledge graph construction in its analysis of the code and contextual information. Without limitation, the prompt generation module 104 may identify the relevant entities from the code, data, and documents; identify relationships between these entities (e.g., certain customers buy certain products, sales are tied to a specific date); then, generate a knowledge graph configured to represent the relationships between these entities. A knowledge graph is a structured representation of information that captures entities and their relationships in a network-like format. The knowledge graph can include nodes representing entities or concepts, and edges representing the relationships between these entities. By constructing a knowledge graph from the analyzed code, data models, and contextual information, the prompt generation module 104 could more effectively identify concepts, dependencies, and relationships within the codebase. This structured representation could enable the system to generate more relevant and context-aware prompts, capturing not just isolated code snippets, but also their place within the larger system architecture and business context.

In example embodiments, the prompt generation module 104 may analyze a Python function and its associated contextual information to generate a prompt. For instance, given a function that calculates the average customer spending per month, the prompt generation module 104 may first tokenize the function name “calculate_average_monthly_spending” into individual words. Through part-of-speech tagging, it may identify “calculate” as a verb, “average” and “monthly” as adjectives, and “spending” as a noun. Entity recognition may identify “customer” as a relevant entity. By analyzing the function's code and associated comments, the prompt generation module 104 may extract information about input parameters (e.g., customer ID, date range) and the output (average spending amount). Based on this analysis, the prompt generation module 104 may generate a prompt such as: “This function calculates the average monthly spending for a given customer over a specified date range, useful for customer behavior analysis.”

In other example embodiments, the prompt generation module 104 may analyze an SQL query and its execution logs. The prompt generation module 104 may tokenize the SQL query, identifying SQL commands (SELECT, FROM, WHERE, etc.) and the table and column names involved. Through semantic analysis, the prompt generation module 104 may understand that the query is joining customer and transaction tables, filtering for high-value transactions, and aggregating results by customer segment. By examining the query logs, the prompt generation module 104 may extract information about the query's typical execution time and the volume of data it processes. Combining this information, the prompt generation module 104 may generate a prompt such as: “This SQL query identifies high-value customers by segment, joining customer and transaction data. It typically processes 1 million rows in 30 seconds, used for quarterly sales reports.”

The generative AI model associated with the prompt generation module 104 may be trained via supervised learning. The supervised learning process may involve feeding the prompt generation module 104 the past code and contextual information, and past prompts associated with the past code and contextual information. The prompt generation module 104 would learn one or more patterns and relationships between the inputs and the desired prompts.

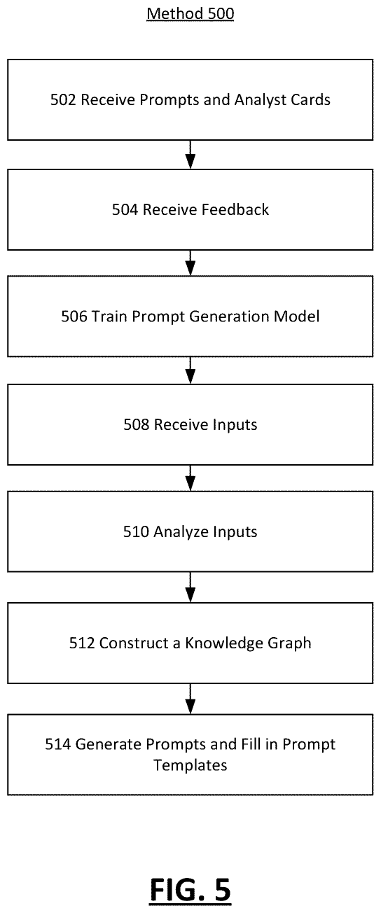

In example embodiments, the prompt generation module 104 may utilize neural networks, such as recurrent neural networks (RNNs) or transformers, to process sequential data like code and text associated with contextual information. These networks may be trained to recognize patterns in the structure and content of the code and contextual information, and to associate these patterns with specific types of prompts. During training, the model may learn to extract relevant features from the code, such as function names, input/output parameters, and code structure. The model may also learn to identify information from the contextual data, such as project requirements, performance metrics, and usage patterns. The model may then learn to map these extracted features to appropriate prompt structures and content. Additionally, the model may employ attention mechanisms to focus on the most relevant parts of the input when generating prompts. This allows it to weigh the importance of different code elements or contextual information based on their relevance to the prompt being generated. Through iterative training on diverse datasets, the model may refine its ability to generate accurate and contextually appropriate prompts for new, unseen code and contextual information. Furthermore, the generative AI model may be trained using supervised, unsupervised, or semi-supervised learning techniques. In some example embodiments, transfer learning can be employed, where a pre-trained model is fine-tuned with a specific dataset related to the code assets to enhance its ability to generate relevant prompts. The training of the prompt generation model is discussed with further reference to FIG. 5.

In other example embodiments, the prompt generation model may be trained with reinforcement learning. As a nonlimiting example, the model may receive feedback on the generated prompts. The feedback may be provided by human users who can rate the quality of the generated prompts. Afterward, the model may adjust its parameters to generate better prompts in the future. In still other example embodiments, the model may be trained by transfer learning. As a nonlimiting example, the model may be trained by pre-trained language models such as, without limitation, BERT or GPT-3 to initialize the model, thereby leveraging the already-established learning techniques of existing models.

Upon ingesting and analyzing the inputs, the prompt generation module 104 may generate prompts based on this analysis. In example embodiments, the prompts generated by the prompt generation module 104 may take various forms, depending on the specific context and requirements of the code asset. As a nonlimiting example, a prompt could be a concise summary of the code's functionality, such as “This function calculates the monthly sales growth rate based on input sales data.” Alternatively, a prompt might provide contextual information about the code's usage, like “Used by the marketing team for quarterly performance analysis.” In some cases, prompts could include performance metrics, such as “Executes within 2 seconds for datasets up to 1 GB in size.” Additionally, prompts may encapsulate business logic or intent, for instance, “Designed to identify high-risk customer segments for targeted retention campaigns.” In other example embodiments, other prompts may be generated of greater length and specificity.

The prompt embedding module 106 may receive the one or more prompts from the prompt generation module 104. The prompt embedding module 106 may embed the one or more prompts into the code. That is, the prompt embedding module 106 may associate each prompt with one or more sections of the code, then embed the prompt in the associated section.

In example embodiments, the prompt embedding module 106 may employ one or more strategies for determining where the prompts should be inserted within the code. The prompt embedding module 106 may perform a semantic analysis of the code to determine where a certain prompt would fit within the code. As a nonlimiting example, the prompt embedding module 106 may analyze the code to understand the code's structure. Based on this analysis, the prompt embedding module 106 may identify specific locations where prompts would be beneficial. As a nonlimiting example, within SQL queries, the prompt embedding module may insert prompts at the beginning of SELECT, WHERE, JOIN, or other SQL clauses where prompts would be most beneficial. As another nonlimiting example, within the data processing steps, the prompt embedding module 106 may insert prompts within functions or loops to provide context about the specific data manipulations being performed by the functions or loops. In other example embodiments, the prompt embedding module 106 may perform a prompt-driven code generation strategy. In this strategy, the prompt embedding module 106 may generate prompts that act as templates and incorporate code snippets into these templates. The prompt embedding module 106 could then fill in the gaps in the code with specific details derived from business documents, data models, and dashboards received at the ingestion step. As a nonlimiting example, the prompt could include SELECT [COLUMN_NAMES], FROM [TABLE_NAME], and WHERE [CONDITION].

In example embodiments, the prompt embedding module 106 may analyze the structure of the code, including function definitions, variable usage, and comments, to identify logical segments where prompts can be meaningfully embedded. For instance, a prompt summarizing a function's purpose may be embedded at the beginning of the function definition, while a prompt detailing performance metrics may be inserted near performance-critical sections of the code. The prompt embedding module 106 may also use machine learning techniques to learn from past embedding decisions, thereby improving its ability to accurately place prompts in the code over time. Additionally, the prompt embedding module 106 may provide an interface for developers to review and adjust the embedded prompts, ensuring that the documentation aligns with their understanding and intentions. This may include modifying, adding, or deleting prompts.

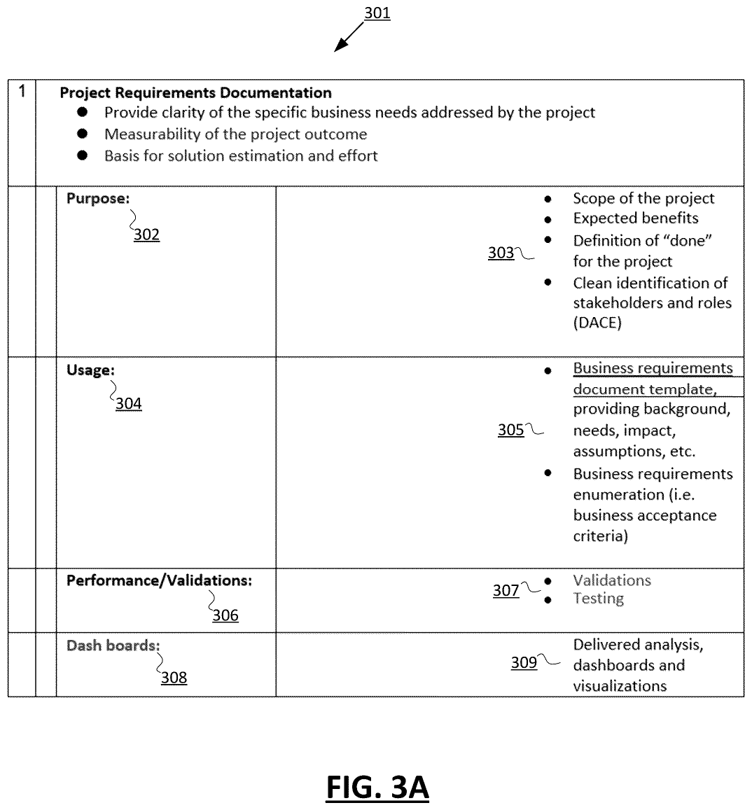

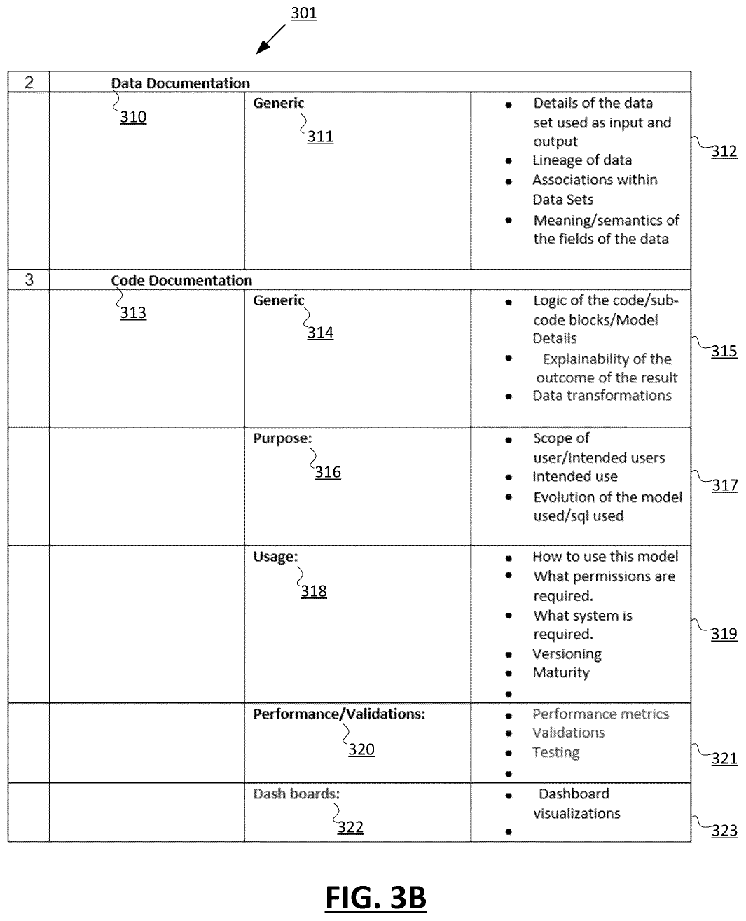

The description generation module 108 may receive the code and code-embedded prompts from the prompt embedding module 106. The description generation module 108 may generate, based on the received code and code embeddings, the analyst card 112 which is a document that formats the information associated with the code and contextual information received from the data collection module 102 and the prompts from the prompt generation module 104. The documentation, discussed with further reference to FIGS. 3A and 3B, may include one or more categories of information, including, without limitation, project requirements documentation, data documentation, code documentation, business metrics documentation, and information about the business owner and code asset owner. Subcategories may include, but are not limited to, integration details, security protocols, scalability assessments, compliance adherence, user interface specifications, dependency mappings, error handling procedures, backup and recovery processes, customization options, deployment guidelines, maintenance schedules, support resources, and historical usage statistics. These subcategories provide additional layers of detail that can further enhance the comprehensiveness and utility of the documentation, facilitating a deeper understanding and broader applicability of the code assets.

In example embodiments, the description generation module 108 may utilize an LLM to generate the analyst card 112. The LLM may generate the description by ingesting the code embeddings, code, and other contextual information, then creating the analyst card 112 based on the foregoing information.

The LLM may employ advanced natural language processing techniques to ensure that the generated documentation is not merely a concatenation of prompts but a well-structured, easily understandable document that flows logically from one section to the next. The LLM may also apply techniques such as attention mechanisms to focus on the prompts that are more relevant to a user's query or the code's functionality, thereby enhancing the relevance and clarity of the generated documentation. In example embodiments, the LLM may extract information from the code and the prompts, including, without limitation, business context, data sources, data transformations performed, expected outputs of the code, and the business intent of the code. Based on the extraction of this information, the LLM may fill one or more template sections with relevant details about the code and associated information.

In example embodiments, the server 101 may train the LLM associated with the description generation module 108 one or more times. The LLM may be trained on a dataset including a collection of code, corresponding prompts for the code, and analyst card descriptions for the code. The code, prompts, and analyst cards may be associated with past projects and retrieved from a database or data storage unit associated with the server 101. The server 101 may train the LLM on code samples to learn code syntax, common patterns, and variable relationships; train the LLM on prompts to understand the language used for describing context and intent; and train the LLM on previous analyst card 112 templates to generate content conforming to the structure and format of these cards. During the training process, the server 101 may evaluate the LLM based on its ability to generate accurate and informative analyst cards. The evaluation may be based on one or more factors, including completeness, including whether the analyst card 112 captures all relevant information about the code; accuracy, including whether the information in the analyst card 112 is factually correct and consistent with the code; and clarity, including whether the description clearly describes the code's purpose and impact.

In example embodiments, the server 101 may store the analyst card 112 templates in a data storage unit or database that is accessible by server 101. This storage unit can be structured to organize the templates to facilitate efficient retrieval based on various criteria, such as project type, code language, or business unit. When an analyst card 112 is requested by a user device 130 or some other device, the server 101 may query the data storage unit to locate the appropriate template. Upon retrieval, the server 101 can dynamically populate the template via the description generation module 108 with the relevant code and contextual information to generate a customized analyst card 112. In example embodiments, the server 101 may categorize the information extracted from the code, contextual information, and the prompts into relevant sections of a template associated with the analyst card 112.

Upon generating the documentation, the server 101 transmits the analyst card 112 to one or more user devices 130 over the network 120. The documentation may be configured to be displayed on one or more user interfaces associated with the user devices 130. The user interface could be a web browser, a dedicated application, or any other software that can render and display the documentation.

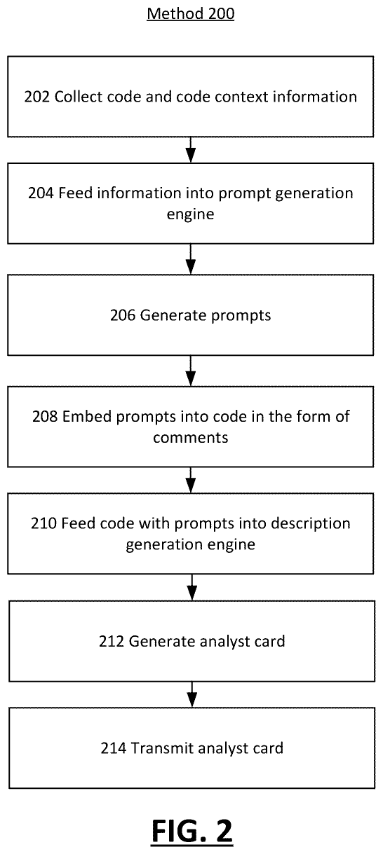

FIG. 2 is a method diagram illustrating the method 200. Each of the actions in method 200 may be performed by the server 101 and its associated modules.

At action 202, the server 101 via the data collection module 102 may collect code and contextual information about the code from the code context server 110 over the network 120. The data collection module 102 may receive the code and contextual information continuously or in batches. In example embodiments, the code and contextual information may include the code itself, SQL identification, query logs, input and output data, query clustering, and other data associated with the code. Other data may include more contextual information including a data model of the code, a lineage analysis exploring the versions or iterations of the code, explainability integration, a profile of experiments done on the code including test time, validation, configurations, setup, and run time instructions for the code; as well as test profiling of the code including performance metrics, execution time, accuracy, and truth metrics, e.g., false positives.

The method 200 may also include a data preprocessing action. In example embodiments, the data collection module 102 may further clean and organize the code and contextual information about the code upon receipt. The data collection module 102 may clean the data by identifying and removing duplicate entries, ensuring that each piece of code and its associated contextual information is represented uniquely within the dataset. In preparing the data for ingestion into the prompt generation module 104, the data collection module 102 may standardize the data formats and normalize the values to create a consistent dataset that can be effectively processed by the prompt generation module 104. This may involve converting various data types to a common format, aligning disparate data structures, and resolving inconsistencies in naming conventions and coding styles.

For example, in one scenario, the data collection module 102 may encounter multiple versions of the same SQL query stored in different repositories. The data collection module 102 may identify these duplicates by comparing the query structures and associated metadata. The data collection module 102 may then retain the most recent or most complete version while archiving or removing the outdated entries. This process ensures that each unique code asset is represented only once in the dataset, reducing redundancy and potential confusion in subsequent analysis.

In another instance, the data collection module 102 may process a mix of Python and SQL code assets. The data collection module 102 may standardize these diverse code formats by converting them into a common intermediate representation. For example, the data collection module 102 may extract information such as function names, input parameters, and output structures from both Python functions and SQL queries, storing this information in a unified format. This standardization allows the prompt generation module 104 to process code assets consistently, regardless of their original language.

Additionally, the data collection module 102 may encounter inconsistencies in naming conventions across different code assets. For instance, some assets may use camelCase for variable names, while others use snake case. The module may apply a set of predefined rules to normalize these naming conventions. It may also leverage machine learning techniques to identify and group semantically similar variables or functions that have been named differently across various code assets. This normalization process facilitates more accurate comparisons and analyses of code structures across the entire dataset, enhancing the system's ability to generate relevant and consistent documentation.

At action 204, the server 101, via the prompt generation module 104, may ingest the code and contextual information collected by the data collection module 102. The prompt generation module 104 may ingest this code and contextual information continuously, in batches, or in response to a query or response from the user devices 130 or some other device.

At action 206, the server 101, via the prompt generation module 104, may generate one or more prompts based on the ingested code and contextual information from the data collection module 102. These prompts may include distilled or summarized versions of the many kinds of data received from the data collection module 102.

In example embodiments, a prompt could be a concise summary of the code's functionality, such as “This function calculates the monthly sales growth rate based on input sales data.” Alternatively, a prompt might provide contextual information about the code's usage, like “Used by the marketing team for quarterly performance analysis.” In some cases, prompts could include performance metrics, such as “Executes within 2 seconds for datasets up to 1 GB in size.” Additionally, prompts may encapsulate business logic or intent, for instance, “Designed to identify high-risk customer segments for targeted retention campaigns.” In other example embodiments, other prompts may be generated of greater length and specificity.

The prompt generation module 104 may use a combination of techniques to generate the prompts. In example embodiments, the prompt generation module 104 may analyze the inputs using NLP and machine learning techniques. The prompt generation module 104 may perform tokenization and part-of-speech tagging, both of which may involve breaking down the text associated with the code and contextual information into meaningful units and identifying the grammatical role of each word. Furthermore, the prompt generation module 104 may perform entity recognition and relation extraction, which may involve identifying entities and relationships within the text.

The prompt generation module 104 may analyze the code and extract information from the code including without limitation functions, variables, dependencies, and comments from the code. In example embodiments, the prompt generation module 104 may Abstract Syntax Trees (AST) parsing. Furthermore, the prompt generation module 104 may analyze the data from the inputs including the data schema, data dictionary, and sample data to identify entities, data types, and relationships among the code. Furthermore, the prompt generation module 104 may ingest dashboards to better understand the visual representations of the data and metrics associated with the code. Based on the analysis of these dashboards, the prompt generation module 104 may generate prompts that focus on the specific insights revealed by the dashboards, such as, without limitation, factors contributing to the decline in sales or a forecast of future sales based on trends observed in a dashboard.

Furthermore, the prompt generation module 104 may employ knowledge graph construction in its analysis of the code and contextual information. Without limitation, the prompt generation module 104 may identify the relevant entities from the code, data, and documents; identify relationships between these entities (e.g., certain customers buy certain products, sales are tied to a specific date); then, generate a knowledge graph configured to represent the relationships between these entities. A knowledge graph is a structured representation of information that captures entities and their relationships in a network-like format. It consists of nodes representing entities or concepts, and edges representing the relationships between these entities. By constructing a knowledge graph from the analyzed code, data models, and contextual information, the prompt generation module 104 could more effectively identify concepts, dependencies, and relationships within the codebase. This structured representation could enable the system to generate more relevant and context-aware prompts, capturing not just isolated code snippets, but also their place within the larger system architecture and business context.

Based on the information extracted through the data analysis, the knowledge graph, and the document analysis, the prompt generation module 104 may generate one or more prompts dynamically or by filling in one or more prompt templates. Such templates may include, without limitation, a template for generating code with placeholders for code snippets, describing the desired outcome of the code, and describing the specific instructions associated with running the code. In other example embodiments, the prompt generation module 104 may learn from past generated prompts by collecting or receiving feedback on the past generated prompts.

In example embodiments, the server 101 may train the generative AI model associated with the prompt generation module 104 as discussed with further reference to FIG. 1 and FIG. 5.

At action 208, the server 101, via the prompt embedding module 106, may receive the code and one or more prompts from the prompt generation module 104. The prompt embedding module 106 may analyze the prompts and the code and based on this analysis, embed the one or more prompts into the code. The prompt embedding module 106 may associate the prompts with one or more sections of the code, then embed the prompt in the associated section.

In example embodiments, the prompt embedding module 106 may employ one or more strategies for determining where the prompts should be inserted within the code. The prompt embedding module 106 may perform a semantic analysis of the code to determine where a certain prompt would fit within the code. As a nonlimiting example, the prompt embedding module 106 may analyze the code to understand the code's structure. Based on this analysis, the prompt embedding module 106 may identify specific locations where prompts would be beneficial. As a nonlimiting example, within SQL queries, the prompt embedding module may insert prompts at the beginning of SELECT, WHERE, JOIN, or other SQL clauses where prompts would be most beneficial. As another nonlimiting example, within the data processing steps, the prompt embedding module 106 may insert prompts within functions or loops to provide context about the specific data manipulations being performed by the functions or loops. In other example embodiments, the prompt embedding module 106 may perform a prompt-driven code generation strategy. In this strategy, the prompt embedding module 106 may generate prompts that act as templates and incorporate code snippets into these templates. The prompt embedding module 106 could then fill in the gaps in the code with specific details derived from business documents, data models, and dashboards received at the ingestion step. As a nonlimiting example, the prompt could include SELECT [COLUMN_NAMES], FROM [TABLE_NAME], and WHERE [CONDITION].

In example embodiments, the prompt embedding module 106 may analyze the structure of the code, including function definitions, variable usage, and comments, to identify logical segments where prompts can be meaningfully embedded. For instance, a prompt summarizing a function's purpose may be embedded at the beginning of the function definition, while a prompt detailing performance metrics may be inserted near performance-critical sections of the code. The prompt embedding module 106 may also use machine learning techniques to learn from past embedding decisions, thereby improving its ability to accurately place prompts in the code over time. Additionally, the prompt embedding module 106 may provide an interface for developers to review and adjust the embedded prompts, ensuring that the documentation aligns with their understanding and intentions. This may include modifying, adding, or deleting prompts.

At action 210, the server 101, via the description generation module 108, ingests the code and prompts from the prompt embedding module 106. The code and prompts may feed continuously or in batches into the description generation module 108.

At action 212, the description generation module 108 may generate, based on the received code and code embeddings, the analyst card 112 that formats the information associated with the code received from the data collection module 102 as well as the prompts from the prompt generation module 104. The documentation may include one or more categories of information, including, without limitation, project requirements documentation, data documentation, code documentation, business metrics documentation, and information about the business owner and code asset owner. Subcategories may include, but are not limited to, integration details, security protocols, scalability assessments, compliance adherence, user interface specifications, dependency mappings, error handling procedures, backup and recovery processes, customization options, deployment guidelines, maintenance schedules, support resources, and historical usage statistics. The analyst cards 112 are discussed with further reference to FIGS. 3A-3B.

In example embodiments, the description generation module 108 may utilize an LLM to generate the description by ingesting the code embeddings, code, and other contextual information, then creating the analyst card 112 based on the foregoing information. The LLM may analyze the embedded prompts and associated sections of code to synthesize a coherent narrative that captures the essence of the code's functionality, operational context, and performance characteristics. The LLM may employ NLP to perform this function. The LLM may also apply techniques such as attention mechanisms to focus on the prompts that are more relevant to the user's query or the code's functionality, thereby enhancing the relevance and clarity of the generated documentation. In example embodiments, the LLM may extract information from the code and the prompts, including without limitation business context, data sources, data transformations performed, expected outputs of the code, and the business intent of the code. Based on the extraction of this information, the LLM may fill one or more template sections with relevant details about the code and associated information. In example embodiments, the server 101 may categorize the information extracted from the code, contextual information, and the prompts into relevant sections of a template associated with the analyst card 112.

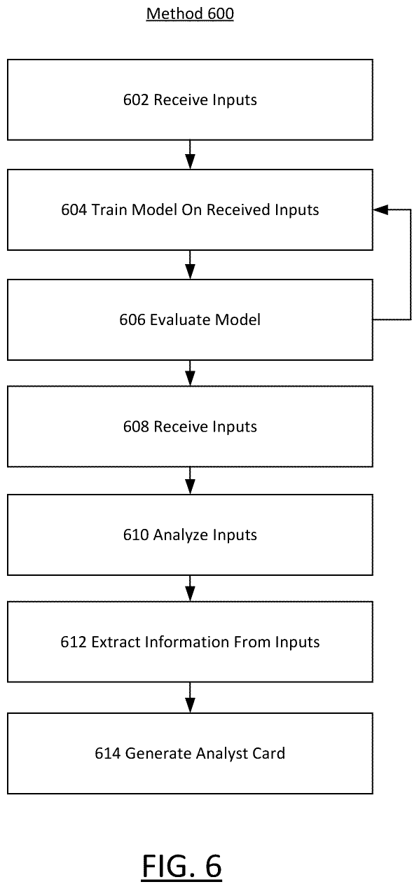

In example embodiments, the LLM associated with the description generation module 108 may be trained to generate analyst card 112s. This training is discussed with further reference to FIG. 6. The LLM may be trained on a dataset including a collection of analyst code with various complexities and purposes, corresponding prompts for the code, and analyst card 112 descriptions for each code snippet. The LLM may also be trained specifically for understanding the code, prompts, and generating structured text. This training may involve training the LLM on code samples to learn code syntax, common patterns, and variable relationships; training the LLM on prompts to understand the language used for describing context and intent; training the LLM on previous analyst card 112 templates to generate content conforming to the structure and format of these cards. During the training process, the LLM may be evaluated based on its ability to generate accurate and informative analyst card 112s. The evaluation may be based on one or more factors, including completeness, including whether the analyst card 112 captures all relevant information about the code; accuracy, including whether the information in the analyst card 112 is factually correct and consistent with the code; and clarity, including whether the description clearly describes the code's purpose and impact.

At action 214, the server 101 may transmit the analyst card 112 to one or more user devices 130 over a network 120. The analyst card 112, further discussed with reference to FIGS. 3A and 3B, may be configured to be displayed on the user devices. The documentation may be configured to be displayed on one or more user interfaces associated with the user devices 130. The user interface could be a web browser, a dedicated application, or any other software that can render and display the documentation.

FIGS. 3A and 3B illustrate analyst cards or documentation. The analyst card 112s may be virtually represented on a user interface associated with the user devices 130.

FIG. 3A illustrates a section of an analyst card 301 with one or more sections dedicated to explaining the Project Requirements Documentation. In example embodiments, the analyst card 301 may provide a subsection with information describing the Project Requirements Documentation, such as providing the specific business needs of the project, the measurability of the project outcome, and the basis for the solution estimate and effort involved. The analyst card 301 may include further subsections describing purpose 302, usage 304, and performance/validations 306, and dashboards 308 associated with the code which is the subject of the analyst card 301. Each subsection may further include description sections 303, 305, 307, and 309. As a nonlimiting example, the purpose 302 section may be accompanied by description section 303 which explains the scope of the project, the expected benefits of the project, the definition of the projects expected end, and the identification of the project's stakeholders and roles involved. Furthermore, the description section 305 of the usage 304 subsection may include a description of the business requirements, document template, background information, project needs, project impact, and project assumptions. The description section 307 of the performance and validation subsection 306 may explain the validations and testing done on the code. The description section 309 of the dashboards 308 subsection may explain the delivered analysis of the code as well as various dashboards and visualizations of the code, code history, and other project actions taken on the code.

FIG. 3B illustrates another section of the analyst card 301. The analyst card 301 may include a data documentation section 310 and a code documentation section 313. The data documentation section 310 may include a generic subsection 311 which has a related description 312 explaining the details of the data set used as input and output regarding the code; the lineage of the data; the associations of the data with one or more data sets; and the meaning and semantics of the fields of the data. The code documentation section 313 may include generic subsection 314 with an accompanying description 315 which explains the logic of the code and sub-code blocks, as well as model details associated with the code; the explainability of the outcome of the result associated with the building and execution of the code; and data transformations. The purpose section 316 may include a description 317 which explains the scope of the code's users and intended users; what permissions are required to access or use the code; what system is required to use the code; how versioning of the code was managed; and other information. The performance and validation section 320 may include a description 323 which explains the performance metrics, validations, and testing done on the code. The dashboards section 322 may include a description 323 explaining the dashboard and other visualization of the code, code history, and other projects on the code.

Although FIGS. 3A and 3B describe only a limited number of sections, subsections, and descriptions, it is understood that the analyst card 301 may include any combination of information described in FIGS. 1-2. In other example embodiments, the analyst card 301 may have nested information within the cards, e.g., expanding tables, referential data, hyperlinks, or some other method of accessing information not immediately available on the analyst card itself.

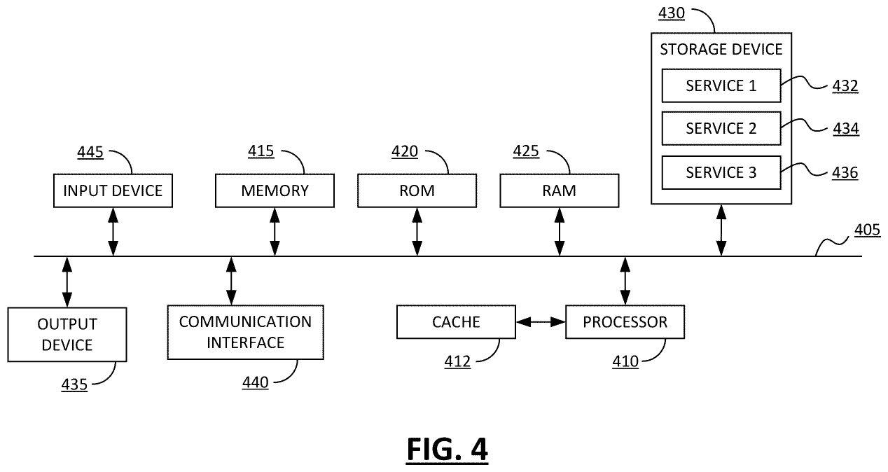

FIG. 4 illustrates an example computing device architecture 400 of an example computing device, e.g., the server 101, that can implement the various techniques described herein. For example, the computing device architecture 400 can implement procedures shown in FIGS. 1-2. The components of computing device architecture 400 are shown in electrical communication with each other using connection 405, such as a bus. The example computing device architecture 400 includes a processing unit (which may include a CPU and/or GPU) 410 and computing device connection 405 that couples various computing device components, including computing device memory 415, such as read-only memory (ROM) 420 and random-access memory (RAM) 425, to processor 410. In some embodiments, a computing device may comprise a hardware accelerator.

Computing device architecture 400 can include a cache of high-speed memory connected directly with, in close proximity to, or integrated as part of processor 410. Computing device architecture 400 can copy data from memory 415 and/or the storage device 430 to cache 412 for quick access by processor 410. In this way, the cache can provide a performance boost that avoids processor 410 delays while waiting for data. These and other modules can control or be configured to control processor 410 to perform various actions. Other computing device memory 415 may be available for use as well. Memory 415 can include multiple different types of memory with different performance characteristics. Processor 410 can include any general-purpose processor and a hardware or software service, such as service 1 432, service 2 434, and service 3 436 stored in storage device 430, configured to control processor 410 as well as a special-purpose processor where software instructions are incorporated into the processor design. Processor 410 may be a self-contained system containing multiple cores or processors, a bus, a memory controller, a cache, etc. A multi-core processor may be symmetric or asymmetric.

To enable user interaction with the computing device architecture, input device 445 can represent any number of input mechanisms, such as a microphone for speech, a touch-sensitive screen for gesture or graphical input, keyboard, mouse, motion input, speech, and so forth. Output device 435 can also be one or more of a number of output mechanisms known to those of skill in the art, such as a display, projector, television, speaker device, etc. In some instances, multimodal computing devices can enable a user to provide multiple types of input to communicate with computing device architecture 400. Communication interface 440 can generally govern and manage the user input and computing device output. There is no restriction on operating on any particular hardware arrangement, and therefore, the basic features here may easily be substituted for improved hardware or firmware arrangements as they are developed.

Storage device 430 is a non-volatile memory and can be a hard disk or other types of computer-readable media that can store data that are accessible by a computer, such as magnetic cassettes, flash memory cards, solid state memory devices, digital versatile disks, cartridges, random access memories (RAMs) 425, read-only memory (ROM) 420, and hybrids thereof. Storage device 430 can include services 432, 434, and 436 for controlling processor 410. Other hardware or software modules are contemplated. Storage device 430 can be connected to the computing device connection 405. In example embodiments, a hardware module that performs a particular function can include the software component stored in a transitory or non-transitory computer-readable medium in connection with the hardware components, such as processor 410, connection 405, output device 435, and so forth, to carry out the function.

FIG. 5 is a method diagram illustrating the method 500. Each of the actions in method 500 may be performed by the server 101 and its associated modules.

At action 502, the server 101 via the prompt generation module 104 may receive one or more code-embedded prompts and analyst cards 112 from previous models for the purpose of training a prompt generation model. In example embodiments, the server 101 may retrieve these past code-embedded prompts and analyst cards 112 from a dedicated database or data storage system. This database may be part of the code context server 110 or may be a separate, specialized repository designed to store historical data related to code documentation. The database may be structured to store and retrieve various versions of prompts and analyst cards 112, along with metadata such as creation date, associated project, and performance metrics.

At action 504, server 101 via the prompt generation module 104 may receive or retrieve feedback on the prompts and analyst cards 112 received in action 502, again for the purpose of training the prompt generation model. For example, the server 101 may receive the feedback from various sources, including end-users, developers, and automated systems. Users may provide qualitative feedback on the usefulness and clarity of the prompts and analyst cards 112s through rating systems or comment forms integrated into the user interface. Developers might offer more technical feedback, focusing on the accuracy of code descriptions and the relevance of embedded prompts. Automated systems could generate quantitative feedback based on metrics such as prompt utilization rates, code reuse statistics, and the frequency of analyst card 112 access.

At action 506, the server 101 via the prompt generation module 104 may enable the prompt generation model to ingest the prompts, analyst cards 112, and feedback for the purpose of training the prompt generation model to generate prompts for the code. In example embodiments, the prompt generation model may include, but is not limited to, various forms of neural networks such as recurrent neural networks (RNNs), long short-term memory networks (LSTMs), and transformer-based models like the Generative Pre-trained Transformer (GPT) series. The training may include supervised learning which may involve feeding the prompt generation module 104 the inputs and pre-generated prompts. The prompt generation model would learn one or more patterns and relationships between the inputs and the desired prompts. The prompt generation model may be trained to recognize patterns in the structure and content of the code and contextual information, and to associate these patterns with specific types of prompts. During training, the prompt generation model may learn to extract relevant features from the code, such as function names, input/output parameters, and code structure. The prompt generation model may also learn to identify information from the contextual data, such as project requirements, performance metrics, and usage patterns. The prompt generation model may then learn to map these extracted features to appropriate prompt structures and content. Additionally, the prompt generation model may employ attention mechanisms to focus on the most relevant parts of the input when generating prompts. This allows the prompt generation model to weigh the importance of different code elements or contextual information based on their relevance to the prompt being generated. Through iterative training on diverse datasets, the prompt generation model may refine its ability to generate accurate and contextually appropriate prompts for new, unseen code and contextual information. The server 101 may train the prompt generation model using supervised, unsupervised, or semi-supervised learning techniques. In some example embodiments, transfer learning can be employed, where a pre-trained model is fine-tuned with a specific dataset related to the code assets to enhance its ability to generate relevant prompts.

In other example embodiments, the server 101 may train the prompt generation model with reinforcement learning. As a nonlimiting example, the prompt generation model may receive feedback on the generated prompts. The server 101 may adjust the prompt generation model's parameters to generate better prompts in the future. In other example embodiments, the server 101 may train the prompt generation model by transfer learning. As a nonlimiting example, the model may be trained by pre-trained language models such as, without limitation, BERT or GPT-3 to initialize the model, thereby leveraging the already-established learning techniques of existing models.

The prompt generation model, upon being trained, may be enabled to analyze the code and contextual information via one or more methods including without limitation tokenization, part-of-speech tagging, NLP, AST parsing, knowledge graph construction, and other tools.

At action 508, the server 101, having trained the prompt generation model, may receive one or more inputs for a new project or assignment including new code and contextual information. In example embodiments, the server 101 may receive inputs, including code and contextual information about the code, SQL identification, query logs, input and output data, query clustering, and other data associated with the code. Other data may include more contextual information including a data model of the code, a lineage analysis exploring the versions or iterations of the code, explainability integration, a profile of experiments done on the code including test time, validation, configurations, setup, and run time instructions for the code; as well as test profiling of the code including performance metrics, execution time, accuracy, and truth metrics, e.g., false positives.

At action 510, the prompt generation model, upon receiving the inputs, may analyze the inputs via one or more methods including without limitation tokenization, part-of-speech tagging, NLP, and other methods. In example embodiments, the prompt generation module 104 may first understand the inputs by analyzing each input using NLP and machine learning techniques. These techniques may involve tokenization and part-of-speech tagging, both of which may involve the prompt generation module 104 breaking down the text associated with the inputs into meaningful units and identifying the grammatical role of each word. Furthermore, the prompt generation module 104 may perform entity recognition and relation extraction, which may involve the prompt generation module 104 identifying entities and relationships within the text. Furthermore, the prompt generation module 104 may perform semantic analysis, which may involve the prompt generation module 104 analyzing the inputs to understand the meaning and context of the input.

In example embodiments, the prompt generation module 104 may analyze the code and extract information from the code including without limitation functions, variables, dependencies, and comments from the code using tools like AST parsing. Furthermore, the prompt generation engine may analyze the data from the inputs including the data schema, data dictionary, and sample data to identify entities, data types, and relationships among the code. Furthermore, the prompt generation module 104 may preprocess the inputs by, without limitation, using NLP techniques to extract phrases, entities, and relationships from the business documents. Furthermore, the prompt generation module 104 may ingest dashboards to better understand the visual representations of the data and metrics associated with the code. Based on the analysis of these dashboards, the prompt generation module 104 may generate prompts that focus on the specific insights revealed by the dashboards, such as, without limitation, factors contributing to the decline in sales or a forecast of future sales based on trends observed in a dashboard.

At action 512, the server 101 via the prompt generation module 104 may construct a knowledge graph. Without limitation, the prompt generation module 104 may identify the relevant entities from the code, data, and documents; identify relationships between these entities (e.g., certain customers buy certain products, sales are tied to a specific date); then generate a knowledge graph configured to represent the relationships between these entities. In example embodiments, a knowledge graph is a structured representation of information that captures entities and their relationships in a network-like format. The knowledge graph may include nodes representing entities or concepts, and edges representing the relationships between these entities. In the context of code analysis, a knowledge graph may be used to visualize and understand the complex interconnections between various components of the code, associated data, and business logic. This graph structure can facilitate more efficient information retrieval, pattern recognition, and inference generation, potentially enhancing the system's ability to generate relevant and contextually appropriate prompts.

At action 514, the server 101 via the prompt generation module 104 and the prompt generation model, having analyzed the inputs and constructed the knowledge graph, may generate one or more prompts. In example embodiments, the prompt generation module 104 may dynamically generate the prompts without any pre-existing templates.

In example embodiments, the prompt generation module 104 may utilize pre-defined templates to structure prompts based on the information derived and analyzed in the prompts. Such templates may include, without limitation, a template for generating code with placeholders for code snippets, describing the desired outcome of the code, and describing the specific instructions associated with running the code. In other example embodiments, the prompt generation module 104 may learn from past generated prompts by collecting or receiving feedback on the past generated prompts. As a nonlimiting example, feedback may include a rating of the effectiveness of the generated prompt.

The prompts generated by the prompt generation module 104 may take various forms, depending on the specific context and requirements of the code asset. As a nonlimiting example, a prompt could be a concise summary of the code's functionality, such as “This function calculates the monthly sales growth rate based on input sales data.” Alternatively, a prompt might provide contextual information about the code's usage, like “Used by the marketing team for quarterly performance analysis.” In other example embodiments, prompts could include performance metrics, such as “Executes within 2 seconds for datasets up to 1 GB in size.” Additionally, prompts may encapsulate business logic or intent, for instance, “Designed to identify high-risk customer segments for targeted retention campaigns.” In other example embodiments, other prompts may be generated of greater length and specificity.

FIG. 6 is a method diagram illustrating the method 600. Each of the actions in method 600 may be performed by the server 101 and its associated modules.

At action 602, the server 101 may receive one or more inputs, including, without limitation, code and contextual information about the code, code-embedded prompts, and analyst cards 112 retrieved from previous projects or models. The contextual information may include SQL identification, query logs, input and output data, query clustering, and other data associated with the code. Other data may include more contextual information, including a data model of the code, a lineage analysis exploring the versions or iterations of the code, explainability integration, a profile of experiments done on the code, including test time, validation, configurations, setup, and run-time instructions for the code; as well as test profiling of the code including performance metrics, execution time, accuracy, and truth metrics, e.g., false positives.

At action 604, the server 101 may train the document generation model associated with the description generation module 107 on the inputs received in action 602. In example embodiments, the server 101 may train the document generation model on code snippets and code samples to teach the document generation model to learn code syntax, code patterns, and relationships between one or more code variables. In example embodiments, the server 101 may train the document generation model using a combination of supervised learning and transfer learning techniques. The document generation model may be initialized with pre-trained language models such as BERT or GPT-3, which provide a foundation for understanding natural language and code structures. The server 101 may then fine-tune this model using a dataset of past inputs, prompts, and analyst card 112s.

In example embodiments, the server 101 may feed the model with pairs of inputs (code snippets, contextual information, and embedded prompts) and their corresponding analyst cards 112. The document generation model may learn to associate specific patterns in the input data with particular sections and content in the analyst cards 112. For example, the document generation model may learn that certain types of code functions often correspond to specific descriptions in the “Purpose” section of an analyst card 112, or that particular metrics in the input data typically appear in the “Performance and Validation” section. In other example embodiments, the document generation model may learn how to generate other sections of the analyst card 112 with further reference to FIGS. 3A-3B.

Furthermore, the document generation model may include an LLM trained to generate analyst cards 112. The LLM associated with the document generation model may be trained on a dataset including a collection of analyst code with various complexities and purposes, corresponding prompts for the code, and analyst card 112 descriptions for each code snippet. The LLM may also be trained specifically for understanding the code, prompts, and generating structured text. This may involve training the LLM on code samples to learn code syntax, common patterns, and variable relationships; training the LLM on prompts to understand the language used for describing context and intent; training the LLM on previous analyst card 112 templates to generate content conforming to the structure and format of these cards. During the training process, the LLM may be evaluated based on its ability to generate accurate and informative analyst card 112s. The evaluation may be based on one or more factors, including completeness, including whether the analyst card 112 captures all relevant information about the code; accuracy, including whether the information in the analyst card 112 is factually correct and consistent with the code; and clarity, including whether the description clearly describes the code's purpose and impact.

At action 606, the server 101 may evaluate the document generation model. In example embodiments, the server 101 may assess the analyst cards 112 for completeness, accuracy of information, and clarity. The server 101 may compare the analyst card 112s to past analyst cards 112 or conduct an ad hoc analysis. In example embodiments, server 101 may re-train the document generation model based on this evaluation. The server 101 may reiterate this training one or more times until the server 101 determines that the document generation model is satisfactory. In example embodiments, the server 101 may employ cross-validation techniques, where the model is trained on different subsets of the available data and tested on the remaining subset, to assess its generalization capabilities. The evaluation process may also include measuring the model's efficiency in terms of processing time and resource utilization, ensuring it can generate analyst cards 112 within acceptable time frames, even for large and complex codebases.

At action 608, the server 101 via the trained document generation model may receive inputs to be fed through the model. In example embodiments, these inputs include code and contextual information, and embedded prompts associated with a new project.

At action 610, the document generation model may analyze the code, contextual information, and embedded prompts. The document generation model may analyze the embedded prompts and associated code sections via NLP.

In example embodiments, the document generation model may use, via the trained LLM, tokenization to break down the code, contextual information, and prompts into individual words or subwords, allowing it to process the text at a granular level. It may then apply part-of-speech tagging to identify the grammatical role of each token, which can help in understanding the structure and meaning of the text. The document generation model may also utilize named entity recognition to identify and classify elements within the code and prompts, such as function names, variable types, or specific business terms. This can help in organizing information for different sections of the analyst card 112. Furthermore, the model may employ semantic analysis techniques to understand the meaning and context of the code and prompts. This may involve using word embeddings or contextual embeddings to capture the semantic relationships between different terms and concepts.

In other example embodiments, the description generation module 108 may utilize the trained LLM to analyze the embedded prompts and associated sections of code to synthesize a coherent narrative that captures the essence of the code's functionality, operational context, and performance characteristics. The LLM may also apply techniques such as attention mechanisms to focus on the prompts that are more relevant to the user's query or the code's functionality, thereby enhancing the relevance and clarity of the generated documentation.

At action 612, the document generation model, based on the analysis of the inputs, may extract information from the inputs that are relevant to the generation of the analyst card 112. In example embodiments, the document generation model may identify business contexts of the inputs, determine data source, recognize data transformations performed, identify expected outputs of the code, and understand the business intent of the code based on the inputs. In other example embodiments, the document generation model may refer to one or more analyst card 112 templates and, based on these templates, extract information that would fill in one or more sections of these templates.

At action 614, the description generation module 108, based on the information extracted in action 612, may generate an analyst card 112. In example embodiments, the description generation module 108 may generate the analyst card 112 by synthesizing a coherent narrative capturing code functionality, context, and performance; structure information using predefined analyst card 112 templates and fill template sections with relevant details from the extracted information.

In other example embodiments, the description generation module 108 may further format the analyst card 112 into categories discussed with further reference to FIGS. 3A-3B.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

Furthermore, the described features and advantages of the embodiments may be combined in any suitable manner. One skilled in the art will recognize that the embodiments may be practiced without one or more of the features or advantages of an embodiment, and one skilled in the art will recognize the features or advantages of an embodiment can be interchangeably combined with the features and advantages of any other embodiments. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

What is claimed is:

1. A system for generating contextual documentation, comprising:
a memory storing instructions; and
a processor executing the instructions to perform operations comprising:
ingesting code and contextual information related to the code;
analyzing the code and the contextual information to determine which of the contextual information describes one or more sections of the code;
generating, via a prompt generation model, one or more prompts describing the one or more sections of the code,
wherein the prompt generation model is trained on a dataset of past code samples, past contextual information associated with the code samples, and one or more past descriptive prompts associated with the code samples;
embedding, via a prompt embedding module, the generated prompts into the code, wherein the embedding further comprises:
performing a semantic analysis of the code to determine one or more code sections for prompt insertion,
associating the prompts with the one or more code sections, and
inserting the prompts at the one or more associated code sections;
generating, via a document generation model, a document, wherein the document formats the contextual information and the embedded prompts,
wherein the document generation model is trained on a dataset of past code samples, past contextual information associated with the code samples, and one or more past documents, and
wherein the generating comprises:
structuring the contextual information and the embedded prompts using predefined document templates; and
filling template sections with the contextual information and the embedded prompts.

2. The system of claim 1, wherein the contextual information comprises SQL identification, query logs, input and output data, query clustering, data models, lineage analysis, explainability integration, experiment profiles, and test profiling.

3. The system of claim 1, wherein the processor is further configured to train the prompt generation model using supervised learning.

4. The system of claim 1, wherein the processor is further configured to train the prompt embedding model to identify the one or more code sections for the prompts based on one or more sets of one or more past code and one or more past embedded prompts.

5. The system of claim 1, wherein the processor is further configured to train the document generation model using a combination of supervised learning and transfer learning techniques.

6. The system of claim 1, wherein the operations further comprise:
constructing, upon preprocessing the code and the contextual information, a knowledge graph representing relationships between one or more entities identified in the code and the contextual information.

7. The system of claim 1, wherein analyzing the code and the contextual information comprises employing tokenization of the code and the contextual information.

8. The system of claim 1, wherein the processor is configured to iteratively train the document generation model by analyzing the generated documents and re-training the document generation model based on one or more errors located in the generated documents.

9. The system of claim 1, wherein the operations further comprise preprocessing the code and the contextual information by removing duplicate entries, standardizing data formats, and normalizing naming conventions.

10. A method for generating contextual documentation, comprising:
ingesting, by a processor, code and contextual information related to the code from a code context server;
generating, by the processor via a trained prompt generation model, one or more prompts based on the code and the contextual information;
embedding, by the processor, the generated prompts into the code wherein the embedding comprises:
performing, by the processor, a semantic analysis of the code to determine one or more code sections for the prompts,
associating, by the processor, the prompts with the one or more code sections, and
inserting, by the processor, the prompts at the associated one or more code sections;
ingesting, by the processor, the code and the embedded prompts into a document generation model;
extracting, by the processor, one or more information from the code and the embedded prompts; and
generating, by the processor via the document generation model, a document that formats the extracted information associated with the code and the embedded prompts.

11. The method of claim 10, wherein generating the one or more prompts further comprises:
ingesting, by the processor, one or more dashboards associated with the code; and
generating, by the trained prompt generation model, one or more prompts comprising information associated with the one or more dashboards.

12. The method of claim 10, wherein generating the one or more prompts further comprises:
constructing, by the processor, a knowledge graph representing relationships between entities identified in the code and the contextual information;
analyzing, by the trained prompt generation model, the knowledge graph to understand the relationships between the entities identified in the code and the contextual information; and
generating, by the trained prompt generation model, prompts comprising information identified in the knowledge graph.

13. The method of claim 10, further comprising:
storing, by the processor, one or more previously generated prompts and previously generated documents in a database;
retrieving, by the processor, the stored prompts and the stored documents for use in training the prompt generation model and the document generation model; and
updating, by the processor, the stored prompts and documents based on one or more feedback received from one or more users.

14. The method of claim 10, further comprising training the document generation model using a combination of supervised learning and transfer learning techniques, initialized with pre-trained language models and fine-tuned on a dataset of past inputs, prompts, and documents.

15. The method of claim 10 further comprising preprocessing, by the processor, the code and the contextual information by removing duplicate entries, standardizing data formats, and normalizing naming conventions.

16. The method of claim 10, wherein the extracting further comprises using an abstract syntax tree to identify one or more code structures within the code.

17. The method of claim 10, further comprising:
providing an interface for one or more users to review and adjust the embedded prompts, wherein the interface allows users to modify, add, or delete prompts within the code.

18. The method of claim 10, wherein generating the document via the document generation model comprises utilizing a large language model (LLM) to analyze the extracted information from the code and the embedded prompts and inputting the analyzed information into a document template.

19. The method of claim 18, wherein generating the document via the trained document generation model further comprises:
analyzing, by the processor via NLP, the extracted information; and
determining, by the processor, one or more placements within the document for the extracted information, wherein the determining further comprises:
performing, by the processor, a semantic analysis of the extracted information to understand the context and meaning of the extracted information, and
categorizing, by the processor, to categorize the extracted information into relevant sections of the document template.

20. A non-transitory computer-readable storage medium storing instructions that, when executed by a processor, cause the processor to perform operations comprising:
ingesting code and contextual information related to the code from a code context server;
generating, via a trained prompt generation model, one or more prompts based on the code and the contextual information;
embedding the generated prompts into the code by:
performing semantic analysis of the code to determine one or more code sections for prompt insertion,
associating prompts with the one or more code sections, and
inserting the prompts at the associated one or more code sections; and
generating, via a trained document generation model, a document comprising the information associated with the code and the embedded prompts.
